(19) United States
(12) Patent Application Publication
(10) Pub. No.: US 2024/0338630 A1
(43) Pub. Date: Oct. 10, 2024

(54) SYSTEMS AND METHODS FOR CONTRASTING GRAPH DATA STRUCTURES

(71) Applicant: Capital One Services, LLC, McLean, VA (US)

(72) Inventors: Samuel SHARPE, Cambridge, MA (US); Grant EDEN, San Francisco, CA (US); Justin AU-YEUNG, Somerville, MA (US)

(73) Assignee: Capital One Services, LLC, McLean, VA (US)

(21) Appl. No.: 18/296,881

(22) Filed: Apr. 6, 2023

(51) Int. Cl. G06Q 10/0637; G06Q 10/0639

(52) U.S. Cl. CPC G06Q 10/06375; G06Q 10/06395; G06Q 10/06398

(57) ABSTRACT

In some aspects, a computing system may generate graph data structures that can be compared with each other to make recommendations. A first graph data structure of the contrasting graphs may be generated based on a first subset of a dataset. For example, the first graph data structure may be generated based on users that have left an organization and graph inference techniques may be used to identify sources that caused the users to leave. A second graph data structure may be generated based on high-performing users of the organization and graph inference techniques may be used to identify potential causes of the users' high performance. The computing system may compare the first and second graph data structures to make recommendations. For example, the computing system may compare the two graphs to determine a modification to make the first graph more similar to the second graph.

### SUMMARY

Data preparation is often the first step and is a key component in a machine learning task. Often data will need to be gathered and modified into a format that is computer-readable and understandable. Advanced preparation to help streamline and improve data for use in machine learning applications can help reduce the amount of time needed to train a machine learning model and increase the quality of a machine learning model's output. Some machine learning models may be used with graph data structures, for example, to perform a variety of tasks including classification, clustering, and regression. The data used by the machine learning model may be represented as a graph of relationships and interactions between objects. Graphs may include nodes and edges that connect nodes with each other. In some cases, nodes in a graph represent objects, and relationships are represented as edges between nodes.

With existing systems, scalability is a key factor that limits the ability of a computing system to use graphs for machine learning applications. Graphs often become too large as they are used to represent interactions or relationships between different objects. For example, a graph that represents relationships or interactions between different users within an organization may become too large for some machine learning applications to complete their objectives in a reasonable amount of time. Thus, it can be difficult to take advantage of graph data in machine learning applications.

To address these issues, non-conventional methods and systems described herein may provide graph data structures that can be used more efficiently, for example, with machine learning applications. Specifically, a computing system may generate novel contrasting graph data structures that can be compared with each other to make recommendations. The contrasting graph data structures may be generated using a portion of the overall data that is available to the computing system and may thereby solve scalability issues described above. A first graph data structure of the contrasting graphs may be generated based on a first subset of a dataset. For example, the first graph data structure may be generated based on users that have left an organization and graph inference techniques may be used to identify sources that caused the users to leave. A second graph data structure may be generated based on high-performing users of the organization and graph inference techniques may be used to identify potential causes of the users' high performance. The computing system may compare the first and second graph data structures to make recommendations. For example, the computing system may compare the two graphs to determine a modification to make the first graph more similar to the second graph. By doing so, the computing system may be able to recommend changes that, for example, eliminate causes for users to leave an organization. Through the use of contrasting graph data structures, the computing system may be able to extract and use a portion of data to solve a task rather than attempting to use an entire dataset, and may thereby be able to more efficiently solve the task (e.g., by using fewer computing resources).

In some aspects, a computing system may generate a negative relationship data structure including a first set of nodes and a first set of edges. A first subset of the first set of nodes may correspond to users who were previously members of an entity but are no longer members. Each edge of the first set of edges may correspond to an interaction between a user represented in the first subset and a user represented in a second subset of the first set of nodes. The computing system may generate, via a first machine learning model, a plurality of quantifiers indicative of user performance within the entity. Each quantifier of the plurality of quantifiers may correspond to a user that is a member (e.g., a current member) of the entity. The computing system may determine, based on the plurality of quantifiers, a set of users. Each user of the set of users may be associated with a quantifier that satisfies a threshold quantifier. The computing system may generate a positive relationship data structure that includes a second set of nodes and a second set of edges. A first portion of the second set of nodes may correspond to the set of users. Each edge of the second set of edges may correspond to an interaction between a user represented in the first portion and a user represented in a second portion of the second set of nodes. The computing system may generate, via a second machine learning model, a first node embedding for a first node in the negative relationship data structure and a second node embedding for a second node in the positive relationship data structure. Based on a distance score associated with the first node embedding and the second node embedding, the computing system may generate an edge that connects the first node of the negative relationship data structure with the second node of the positive relationship data structure.

Various other aspects, features, and advantages of the invention will be apparent through the detailed description of the invention and the drawings attached hereto. It is also to be understood that both the foregoing general description and the following detailed description are examples and are not restrictive of the scope of the invention. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (e.g., the entire portion), a given item (e.g., data) unless the context clearly dictates otherwise.

### BRIEF DESCRIPTION OF THE DRAWINGS

FIG. 1 shows an example system for generating and using contrasting graph data structures, in accordance with one or more embodiments.

FIG. 2 shows an example graph, in accordance with one or more embodiments.

FIG. 3 shows illustrative components for a system generating and using node embeddings. in accordance with one or more embodiments.

FIG. 4 shows a flowchart of the steps involved in using graphs to make recommendations, in accordance with one or more embodiments.

### DETAILED DESCRIPTION OF THE DRAWINGS

In the following description, for the purposes of explanation, numerous specific details are set forth in order to provide a thorough understanding of the embodiments of the invention. It will be appreciated, however, by those having skill in the art that the embodiments of the invention may be practiced without these specific details or with an equivalent arrangement. In other cases, well-known structures and devices are shown in block diagram form in order to avoid unnecessarily obscuring the embodiments of the invention.

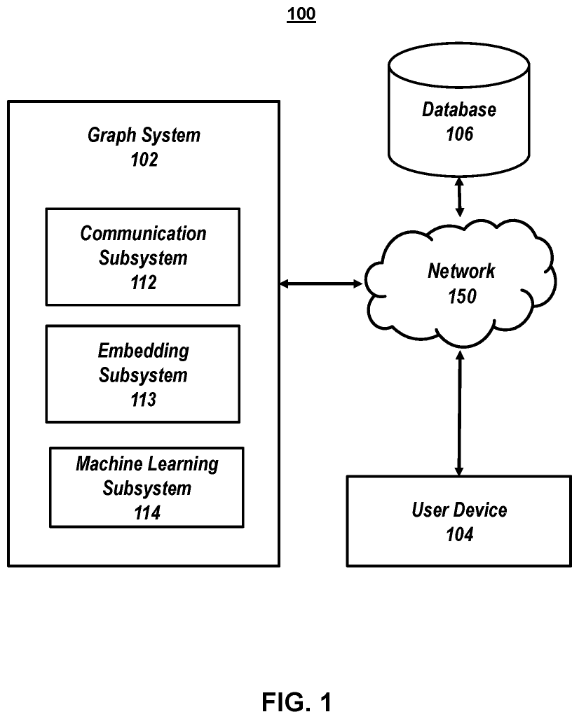

FIG. 1 shows an illustrative system 100 for facilitating configuration of machine learning models for different purposes (e.g., based on “multipurpose” node embeddings generated via aggregation of multi-dimensional data representations of nodes), in accordance with one or more embodiments. The system 100 may generate novel contrasting graph data structures that can be compared with each other to make recommendations. The contrasting graph data structures may be generated using a portion of the overall data that is available to the computing system and may thereby prevent scalability issues described above. A first graph data structure of the contrasting graphs may be generated based on a first subset of a dataset. For example, the first graph data structure may be generated based on users that have left an organization, and graph inference techniques may be used to identify sources that caused the users to leave. A second graph data structure may be generated based on high-performing users of the organization and graph inference techniques may be used to identify potential causes of the users' high performance. The system 100 may compare the first and second graph data structures to make recommendations. For example, the computing system may compare the two graphs to determine a modification to make the first graph more similar to the second graph. By doing so, the computing system may be able to recommend changes that, for example, eliminate causes for users to leave an organization. Through the use of contrasting graph data structures, the computing system may be able to extract and use a portion of data to solve a task rather than attempting to use an entire dataset and may thereby be able to more efficiently solve the task (e.g., by using fewer computing resources).

The system 100 may include a graph system 102, a database 106, and a user device 104. The graph system 102, database 106, and user device 104 may communicate with each other via a network 150. The graph system 102 may include a communication subsystem 112, an embedding subsystem 113, a machine learning subsystem 114, or other components.

The graph system 102 may generate a first graph based on users who are no longer members of an entity. An entity may be any thing with distinct or independent existence. An entity may be an organization. An entity may be a company, a collection of users, an institution, government, or administration. Members of an entity may be employees of a company. The graph system 102 may generate a negative relationship data structure that includes a first set of nodes and a first set of edges. A negative relationship data structure may include a graph with nodes representing members or former members of an entity and edges representing interactions between the members or former members. A first subset of the first set of nodes may correspond to users who were previously members of the entity but are no longer members. For example, the first subset of the first set of nodes may include users that are former employees of an organization. In one example, the first subset may include all employees that have quit or have been terminated from the organization within a threshold time period (e.g., within the last two years, six months, etc.). Each edge of the first set of edges may correspond to one or more interactions between a user (e.g., member or former member of the entity) represented in the first subset of nodes and a user represented in a second subset of the first set of nodes. An interaction between two users may include one user sending a message or other communication to another user. An interaction may include a meeting, a phone call, sharing of a document or other work product, or a variety of other interactions.

In one example, there may be an edge for each recorded interaction that a former employee had with other users associated with the organization. For example, if a former employee had ten interactions with a first user, three interactions with a second user, and thirty interactions with a third user, there may be 43 edges connected to a node that represents the former employee. In this example, there may be ten edges that connect the former employee with the first user (e.g., a node of the former employee with a node of the first user), three edges that connect the former employee with the second user, and thirty interactions that connect the former employee with the third user. By generating a data structure in this way with interactions as edges that connect former employees to other employees, clients, or other users, the graph system 102 may enable a machine learning model to generate improved node embeddings that can be used to better identify causes of employee turnover. For example, by identifying interactions with former employees, the data structure can be used to generate node embeddings that are more representative of other users that may have caused the former employees to leave the organization, thus enabling the graph system 102 to determine changes that should be made to prevent future turnover. Further, the data structure may be used in conjunction with a second data structure to enable a machine learning model to generate recommendations, for example, as described in more detail below.

The graph system 102 (e.g., via the embedding subsystem 113) may generate node embeddings based on nodes contained in one or more graph data structures described herein. A node embedding may be a vector (e.g., a list of values) that represents a node. Node embeddings may encode or represent nodes such that two nodes that are similar in a graph have similar node embeddings. Similarity between two node embeddings may be determined via a dot product or a distance metric (e.g., Cosine similarity, Euclidean distance, Manhattan distance, Minkowski distance, etc.). For example, the graph system 102 may determine that two nodes are similar if a distance metric between their corresponding node embeddings is less than a threshold distance. A node embedding may include multiple values. The number of values in a node embedding may be referred to as the number of dimensions. For example, a node embedding may have a dimension of 150, 300, 2000, or a variety of other dimensions.

Node embeddings may be generated using an unsupervised machine learning technique. An unsupervised machine learning technique may include the use of a machine learning model that learns patterns from unlabeled data (e.g., data without labeled classes). The graph system 102 may generate an unsupervised learning set of node embeddings by inputting data corresponding to graph nodes of a graph into an unsupervised embedding model. The graph system 102 may use a technique that uses the context of a node (e.g., skip-gram with negative sampling and random walks) to generate an embedding for the first set of nodes. For example, the graph system 102 may use Node2vec to generate the unsupervised learning set of node embeddings. The set of node embeddings may be generated using a variety of transductive machine learning techniques. The first set of node embeddings may include a different node embedding for each node in a graph. In some embodiments, the first set of node embeddings may include a node embedding for each node of a portion of the nodes in the graph.

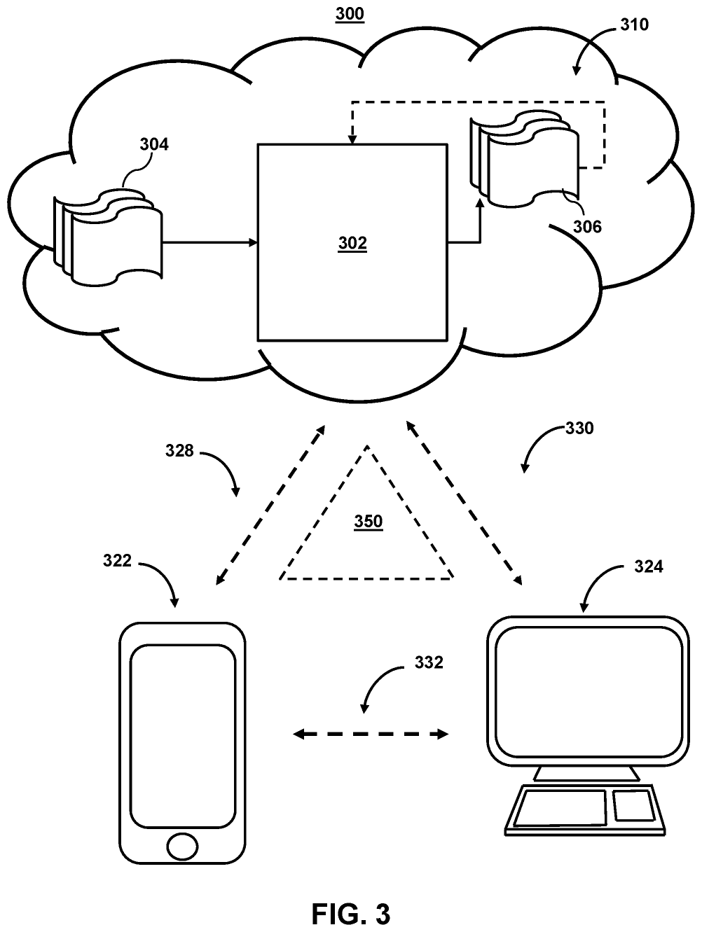

Node embeddings may be generated using a supervised machine learning technique. A supervised machine learning technique may include using a machine learning model (e.g., as described below in connection with FIG. 3) that has been trained using a labeled dataset to classify data or predict outcomes. The graph system 102 may generate node embeddings by inputting data corresponding to the graph nodes into a supervised embedding model. The graph system 102 may train a machine learning model that uses a node's features (e.g., text attributes, connected nodes, or any other node data) to generate an embedding for a node. For example, the graph system 102 may use GraphSAGE, GraphSAINT, a graph convolutional network, or a variety of other techniques to generate node embeddings. The node embeddings may include a different node embedding for each node in a graph. In some embodiments, the second set of node embeddings may include a node embedding for each node of a portion of the nodes in the graph.

In some embodiments, the graph system 102 may generate labels for the graph so that node embeddings can be generated via a supervised machine learning technique. For example, the graph system 102 may determine, based on data associated with a first node, that a first feature is greater than a threshold feature value. Based on determining that the first feature is greater than a threshold feature value, the graph system 102 may assign a first label to the first node.

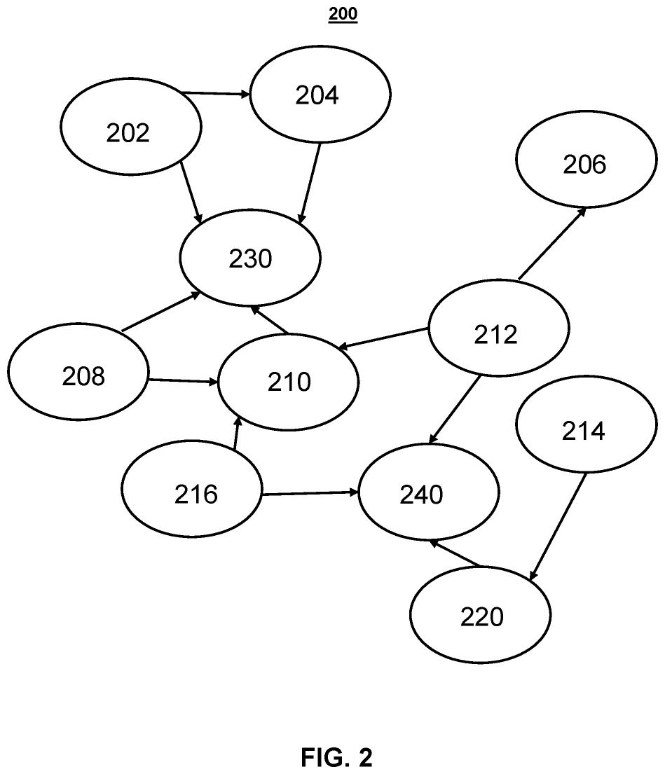

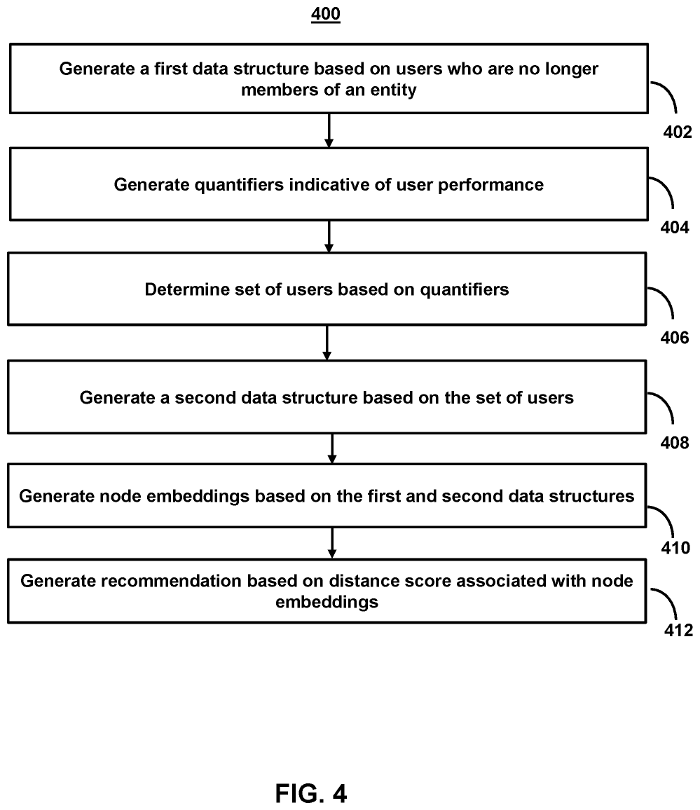

Referring to FIG. 2, an example graph 200 including nodes and edges is shown. The graph 200 may be a negative relationship graph data structure (e.g., as described in connection with FIG. 1 or FIG. 4). A node in the graph 200 may represent or otherwise indicate an employee, person, user, customer, team, product, software code repository, system, dataset, document, resource, project, or a variety of other entities or items. An edge (e.g., edge 203 or edge 230) may indicate that one or more interactions occurred between users represented by the connected nodes. The graph 200 may be created based on users or members that have left an entity. For example, node 202, node 204, node 208, node 210, node 212, and node 220 may correspond to employees who no longer work at a company. The graph system 102 may determine other employees that each of nodes 202, 204, 208, 210, 212, and 220 interacted with and may create corresponding nodes. For example, nodes 214 and 240 may have interacted with node 220. Nodes 202, 204, 208, and 210 may have interacted with node 230. The graph system 102 may determine (e.g., via graph inference techniques) that some nodes have more interactions with nodes corresponding to employees that no longer work at a company. The employees that correspond to nodes that have more interactions with nodes corresponding to employees that no longer work at the company may be determined to be causing employees to leave. For example, the graph system 102 may identify employees corresponding to node 230 and node 240 as causes for other employees to leave, for example, due to the large number of connections with other nodes. The computing system 102 may generate recommendations for changes to prevent employees from leaving the company as described in more detail below.

Referring back to FIG. 1, the graph system 102 may generate quantifiers indicative of user performance. The quantifiers may be used to identify high-performing users within an organization and may be used to generate a second data structure (e.g., graph) as described in more detail below. In one example, the graph system 102 may generate, via a first machine learning model, a plurality of quantifiers indicative of user performance within the entity. For example, the quantifiers may be generated by inputting data related to performance reviews, promotions (e.g., the number of times an employee was promoted within a threshold period of time), or a variety of other performance related data. A machine learning model may generate a quantifier or score based on the data (e.g., performance related data) for each user. In one example, to generate the plurality of quantifiers the graph system 102 may process, via the first machine learning model, text associated with a user to generate a sentiment associated with the text. The text may include a review of the user. The first machine learning model may include a sentiment analysis model. In this example, based on the sentiment, the graph system 102 may generate a first quantifier of the plurality of quantifiers. Each quantifier of the plurality of quantifiers may correspond to a user that is a member of the entity. By generating quantifiers, for example, for each user, the graph system 102 may be able to determine which users may be good examples for other users that may need training.

The graph system 102 may determine a set of users based on the quantifiers generated as described above. The quantifiers may be used to determine a set of users that may be high performers within the organization. The set of users may then be used to generate an additional data structure which may be used by the graph system 102 (e.g., via a machine learning model) to generate recommendations, for example, related to preventing employee turnover at an organization. In one example, the graph system 102 may determine, based on the plurality of quantifiers, a set of users, wherein each user of the set of users is associated with a quantifier that is higher than a threshold quantifier.

The graph system 102 may generate a second data structure based on the set of users. For example, the graph system 102 may generate a positive relationship data structure (e.g., a graph that is generated based on high performers) that includes a second set of nodes and a second set of edges. A first portion of the second set of nodes may correspond to the set of users that are high performers. Each edge of the second set of edges may correspond to an interaction between a user represented in the first portion and a user represented in a second portion of the second set of nodes. For example, the first portion of the second set of nodes may include users that were determined to be high performers within an organization. The edges in the second set of edges may correspond to interactions that the high performers had with other users, employees, clients, vendors, etc. By constructing the second data structure in this way, the graph system 102 may be able to generate a data structure that can act as a counterfactual sample to the data structure that was generated. The two data structures may be compared, for example, to identify causes of employee turnover at an organization.

The graph system 102 may generate node embeddings based on the first and second data structures. For example, the graph system 102 may generate, via a second machine learning model, a first node embedding for a first node in the negative relationship data structure and may generate a second node embedding for a second node in the positive relationship data structure. The graph system 102 may generate node embeddings for each node in the first graph that corresponds to a user that is still a member of the entity. For example, the graph system 102 may avoid generating node embeddings for users that have left the organization. By doing so, the graph system 102 can generate node embeddings that can be used to determine changes or recommendations for users that are still members of the entity. The node embeddings may be compared to determine whether two nodes are similar. The graph system 102 may generate a recommendation that a user associated with a first node should train a user associated with a second node, for example, if two nodes are similar (e.g., as described in more detail below).

The graph system 102 may generate a recommendation based on a distance score associated with the generated node embeddings. For example, based on a distance score associated with the first node embedding and the second node embedding, the graph system 102 may generate an edge that connects the first node of the negative relationship data structure with the second node of the positive relationship data structure. The distance score may indicate how similar two nodes are. The distance score may be Cosine distance, Euclidean distance, or a variety of other distance scores. The edge that connects the first node with the second node may indicate that a user represented by the first node should be trained by a user represented by the second node. By generating a connection between the two nodes, the graph system 102 may keep track of training recommendations.

In some embodiments, a recommendation to have a user train another user may be based on whether the distance score satisfies a threshold. For example, a recommendation to have one user train another user may be based on whether the distance score that is generated using corresponding node embeddings is lower than a threshold distance score. In one example, generating a recommendation (e.g., generating an edge that connects the first node of the negative relationship data structure with the second node of the positive relationship data structure) may be based on the distance score satisfying a threshold distance score.

In some embodiments, the graph system 102 may compare the first data structure (e.g., the negative relationship data structure) with the second data structure (e.g., the positive relationship data structure) to determine a recommendation. For example, based on comparing the positive relationship data structure with the negative relationship data structure, the graph system 102 may determine a first node for modification. The graph system 102 may generate a recommendation associated with the first node.

In some embodiments, the graph system 102 may compare the first data structure with the second data structure by comparing a first embedding that represents the first data structure (e.g., that represents the entire first data structure as a whole) with a second embedding that represents the second data structure. For example, the graph system 102 may generate a first data structure embedding representative of the negative relationship data structure and may generate a second data structure embedding representative of the positive relationship data structure. The graph system 102 may determine that a distance score associated with the first data structure embedding and the second data structure embedding satisfies a threshold. If the threshold is satisfied, the graph system 102 may determine that the two data structures are similar. By doing so, the graph system 102 may be able to recommend a feature that is present in the positive relationship data structure but missing in the negative relationship data structure as a feature to change (e.g., for one or more users in the negative relationship data structure). For example, based on the distance score satisfying a threshold, the graph system 102 may determine a feature, wherein a first value of the feature for the positive relationship data structure is greater than (e.g., or less than, for example, depending on the feature) a second value of the feature for the negative relationship data structure. Based on the feature, the graph system 102 may send a recommendation to a user device. For example, the graph system 102 may send a recommendation to increase a salary of one or more users if the identified feature is income level. As an additional example, the graph system 102 may send a recommendation to hire additional employees for a particular team if the identified feature is team size (e.g., the size of the team in the negative relationship data structure is smaller (e.g., by more than a threshold number of employees) than the size of the team in the positive relationship data structure).

In some embodiments, the graph system 102 may determine a feature based on a list of features. For example, the list of features may include salary, the number of team members, the number of users (e.g., the average number of nodes that are connected to users via an edge), or a variety of other features. The graph system 102 may compare a value of the feature (e.g., an average or median value of the feature) of one or more users in the negative relationship data structure with a value of the feature of one or more users in the positive relationship data structure. For example, the graph system 102 may compare an income level of a first user in the negative relationship data structure with an income level of a second user in the positive relationship data structure. If the first user in the negative relationship data structure has an income that is more than a threshold amount lower than the second user in the positive relationship data structure, the graph system 102 may generate a recommendation indicating that the income level of the first user should be increased. As an additional example, the graph system 102 may compare a team size (e.g., the number of nodes) in the negative relationship data structure with a team size (e.g., the number of nodes) in the positive relationship data structure. If the team size in the negative relationship data structure is lower by more than a threshold number of team members, the graph system 102 may generate a recommendation indicating that the number of team members should be increased.

In some embodiments, the graph system 102 may generate a visualization of one or more data structures described above. For example, the graph system 102 may generate a user interface comprising a visualization of the negative relationship data structure and the positive relationship data structure and may cause display of the user interface.

FIG. 3 shows illustrative components for a system used for configuration of machine learning models for different purposes (e.g., to generate recommendations based on graphs as described in connection with FIG. 1, FIG. 2, or FIG. 4), in accordance with one or more embodiments. For example, FIG. 3 shows illustrative components for using distance scores to evaluate quality levels of machine learning explanations. As shown in FIG. 3, system 300 may include mobile device 322 and user terminal 324. While shown as a smartphone and personal computer, respectively, in FIG. 3, it should be noted that mobile device 322 and user terminal 324 may be any computing device, including, but not limited to, a laptop computer, a tablet computer, a handheld computer, and other computer equipment (e.g., a server), including “smart,” wireless, wearable, mobile devices, and/or any device or system described in connection with FIGS. 1-2. FIG. 3 also includes cloud components 310. Cloud components 310 may alternatively be any computing device as described above, and may include any type of mobile terminal, fixed terminal, or other device. For example, cloud components 310 may be implemented as a cloud computing system, and may feature one or more component devices. It should also be noted that system 300 is not limited to three devices. Users may, for instance, utilize one or more devices to interact with one another, one or more servers, or other components of system 300. It should be noted, that, while one or more operations are described herein as being performed by particular components of system 300, these operations may, in some embodiments, be performed by other components of system 300. As an example, while one or more operations are described herein as being performed by components of mobile device 322, these operations may, in some embodiments, be performed by components of cloud components 310. In some embodiments, the various computers and systems described herein may include one or more computing devices that are programmed to perform the described functions. Additionally, or alternatively, multiple users may interact with system 300 and/or one or more components of system 300. For example, in one embodiment, a first user and a second user may interact with system 300 using two different components.

With respect to the components of mobile device 322, user terminal 324, and cloud components 310, each of these devices may receive content and data via input/output (I/O) paths. Each of these devices may also include processors and/or control circuitry to send and receive commands, requests, and other suitable data using the I/O paths. The control circuitry may comprise any suitable processing, storage, and/or I/O circuitry. Each of these devices may also include a user input interface and/or user output interface (e.g., a display) for use in receiving and displaying data. For example, as shown in FIG. 3, both mobile device 322 and user terminal 324 include a display upon which to display data (e.g., conversational response, queries, and/or notifications).

Additionally, as mobile device 322 and user terminal 324 are shown as touchscreen smartphones, these displays also act as user input interfaces. It should be noted that in some embodiments, the devices may have neither user input interfaces nor displays, and may instead receive and display content using another device (e.g., a dedicated display device, such as a computer screen, and/or a dedicated input device such as a remote control, mouse, voice input, etc.). Additionally, the devices in system 300 may run an application (or another suitable program). The application may cause the processors and/or control circuitry to perform operations related to generating dynamic conversational replies, queries, and/or notifications.

Each of these devices may also include electronic storages. The electronic storages may include non-transitory storage media that electronically stores information. The electronic storage media of the electronic storages may include one or both of (i) system storage that is provided integrally (e.g., substantially non-removable) with servers or client devices, or (ii) removable storage that is removably connectable to the servers or client devices via, for example, a port (e.g., a USB port, a firewire port, etc.) or a drive (e.g., a disk drive, etc.). The electronic storages may include one or more of optically readable storage media (e.g., optical disks, etc.), magnetically readable storage media (e.g., magnetic tape, magnetic hard drive, floppy drive, etc.), electrical charge-based storage media (e.g., EEPROM, RAM, etc.), solid-state storage media (e.g., flash drive, etc.), and/or other electronically readable storage media. The electronic storages may include one or more virtual storage resources (e.g., cloud storage, a virtual private network, and/or other virtual storage resources). The electronic storages may store software algorithms, information determined by the processors, information obtained from servers, information obtained from client devices, or other information that enables the functionality as described herein.

FIG. 3 also includes communication paths 328, 330, and 332. Communication paths 328, 330, and 332 may include the Internet, a mobile phone network, a mobile voice or data network (e.g., a 5G or Long-Term Evolution (LTE) network), a cable network, a public switched telephone network, or other types of communications networks or combinations of communications networks. Communication paths 328, 330, and 332 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. The computing devices may include additional communication paths linking a plurality of hardware, software, and/or firmware components operating together. For example, the computing devices may be implemented by a cloud of computing platforms operating together as the computing devices. Cloud components 310 may include, for example, the graph system 102 or the user device 104 described in connection with FIG. 1.

Cloud components 310 may include model 302, which may be a machine learning model, artificial intelligence model, etc. (which may be collectively referred to herein as “models”). Model 302 may take inputs 304 and provide outputs 306. The inputs may include multiple datasets, such as a training dataset and a test dataset. Each of the plurality of datasets (e.g., inputs 304) may include data subsets related to user data, predicted forecasts and/or errors, and/or actual forecasts and/or errors. In some embodiments, outputs 306 may be fed back to model 302 as input to train model 302 (e.g., alone or in conjunction with user indications of the accuracy of outputs 306, labels associated with the inputs, or with other reference feedback information). For example, the system may receive a first labeled feature input, wherein the first labeled feature input is labeled with a known prediction for the first labeled feature input. The system may then train the first machine learning model to classify the first labeled feature input with the known prediction (e.g., to generate recommendations based on graphs as described in connection with FIG. 1, FIG. 2, or FIG. 4).

In a variety of embodiments, model 302 may update its configurations (e.g., weights, biases, or other parameters) based on the assessment of its prediction (e.g., outputs 306) and reference feedback information (e.g., user indication of accuracy, reference labels, or other information). In a variety of embodiments, where model 302 is a neural network, connection weights may be adjusted to reconcile differences between the neural network's prediction and reference feedback. In a further use case, one or more neurons (or nodes) of the neural network may require that their respective errors are sent backward through the neural network to facilitate the update process (e.g., backpropagation of error). Updates to the connection weights may, for example, be reflective of the magnitude of error propagated backward after a forward pass has been completed. In this way, for example, the model 302 may be trained to generate better predictions.

In some embodiments, model 302 may include an artificial neural network. In such embodiments, model 302 may include an input layer and one or more hidden layers. Each neural unit of model 302 may be connected with many other neural units of model 302. Such connections can be enforcing or inhibitory in their effect on the activation state of connected neural units. In some embodiments, each individual neural unit may have a summation function that combines the values of all of its inputs. In some embodiments, each connection (or the neural unit itself) may have a threshold function such that the signal must surpass it before it propagates to other neural units. Model 302 may be self-learning and trained, rather than explicitly programmed, and can perform significantly better in certain areas of problem solving, as compared to traditional computer programs. During training, an output layer of model 302 may correspond to a classification of model 302, and an input known to correspond to that classification may be input into an input layer of model 302 during training. During testing, an input without a known classification may be input into the input layer, and a determined classification may be output.

In some embodiments, model 302 may include multiple layers (e.g., where a signal path traverses from front layers to back layers). In some embodiments, backpropagation techniques may be utilized by model 302 where forward stimulation is used to reset weights on the “front” neural units. In some embodiments, stimulation and inhibition for model 302 may be more free-flowing, with connections interacting in a more chaotic and complex fashion. During testing, an output layer of model 302 may indicate whether or not a given input corresponds to a classification of model 302.

In some embodiments, the model (e.g., model 302) may automatically perform actions based on outputs 306. In some embodiments, the model (e.g., model 302) may not perform any actions. The model (e.g., model 302) may generate a variety of node embeddings based on a node that is input into the model (e.g., as described above in connection with FIG. 1, 2, or 4). The model may generate aggregated embeddings based on the variety of node embeddings. Additionally or alternatively, the model may be configured (e.g., trained) using an aggregated set of node embeddings as described herein.

System 300 also includes application programming interface (API) layer 350. API layer 350 may allow the system to generate summaries across different devices. In some embodiments, API layer 350 may be implemented on user device 322 or user terminal 324. Alternatively, or additionally, API layer 350 may reside on one or more of cloud components 310. API layer 350 (which may be a representational state transfer (REST) or web services API layer) may provide a decoupled interface to data and/or functionality of one or more applications. API layer 350 may provide a common, language-agnostic way of interacting with an application. Web services APIs offer a well-defined contract, called WSDL, that describes the services in terms of its operations and the data types used to exchange information. REST APIs do not typically have this contract; instead, they are documented with client libraries for most common languages, including Ruby, Java, PHP, and JavaScript. Simple Object Access Protocol (SOAP) web services have traditionally been adopted in the enterprise for publishing internal services, as well as for exchanging information with partners in B2B transactions.

API layer 350 may use various architectural arrangements. For example, system 300 may be partially based on API layer 350, such that there is strong adoption of SOAP and RESTful web services, using resources like Service Repository and Developer Portal, but with low governance, standardization, and separation of concerns. Alternatively, system 300 may be fully based on API layer 350, such that separation of concerns between layers like API layer 350, services, and applications are in place.

In some embodiments, the system architecture may use a microservice approach. Such systems may use two types of layers: front-end layer and back-end layer where microservices reside. In this kind of architecture, the role of the API layer 350 may provide integration between front-end layer and back-end layer. In such cases, API layer 350 may use RESTful APIs (exposition to front-end layer or even communication between microservices). API layer 350 may use AMQP (e.g., Kafka, RabbitMQ, etc.). API layer 350 may use incipient usage of new communications protocols such as gRPC, Thrift, etc.

In some embodiments, the system architecture may use an open API approach. In such cases, API layer 350 may use commercial or open source API Platforms and their modules. API layer 350 may use a developer portal. API layer 350 may use strong security constraints applying web application firewall (WAF) and distributed denial-of-service (DDoS) protection, and API layer 350 may use RESTful APIs as standard for external integration.

FIG. 4 shows a flowchart of the steps involved in facilitating configuration of machine learning models for different purposes (e.g., based on “multipurpose graph” embeddings generated via aggregation of multi-dimensional data representations of nodes), in accordance with one or more embodiments. Although described as being performed by a computing system, one or more steps of FIG. 4 may be performed by other computing devices, for example, such as one or more devices shown in FIGS. 1-3. The processing operations presented below are intended to be illustrative and non-limiting. In some embodiments, for example, the method may be accomplished with one or more additional operations not described, or without one or more of the operations discussed. Additionally, the order in which the processing operations of the methods are illustrated (and described below) is not intended to be limiting.

At step 402, the computing system may generate a first graph based on users who are no longer members of an entity. For example, the computing system may generate a negative relationship data structure (e.g., a graph that is generated based on members that have left an entity) that includes a first set of nodes and a first set of edges. A first subset of the first set of nodes may correspond to users who were previously members of the entity but are no longer members. For example, the first subset of the first set of nodes may include users that are former employees of an organization. In one example, the first subset may include all employees that have quit or been terminated from the organization within a threshold time period (e.g., within the last two years, six months, etc.). Each edge of the first set of edges may correspond to one or more interactions between a user represented in the first subset of nodes and a user represented in a second subset of the first set of nodes. For example, there may be an edge for each recorded interaction that a former employee had with other users associated with the organization. For example, if a former employee had ten interactions with a first user, three interactions with a second user, and thirty interactions with a third user, there may be 43 edges connected to a node that represents the former employee. In this example, there may be ten edges that connect the former employee with the first user (e.g., a node of the former employee with a node of the first user), three edges that connect the former employee with the second user, and thirty interactions that connect the former employee with the third user. By generating a data structure in this way with interactions as edges that connect former employees to other employees, clients, or other users, the computing system may enable a machine learning model to generate improved node embeddings that can be used to better identify causes of employee turnover. For example, by identifying interactions with former employees, the data structure can be used to generate node embeddings that are more representative of other users that may have caused the former employees to leave the organization, thus enabling the computing system to determine changes that should be made to prevent future turnover. Further, the data structure may be used in conjunction with a second data structure to enable a machine learning model to generate recommendations, for example, as described in more detail below.

At step 404, the computing system may generate quantifiers indicative of user performance. The quantifiers may be used to identify high-performing users within an organization and may be used to generate a second data structure (e.g., graph) as described in more detail below. In one example, the computing system may generate, via a first machine learning model, a plurality of quantifiers indicative of user performance within the entity. For example, the quantifiers may be generated by inputting data related to performance reviews, promotions (e.g., the number of times an employee was promoted within a threshold period of time), or a variety of other performance related data. A machine learning model may generate a quantifier or score based on the data (e.g., performance related data) for each user. In one example, to generate the plurality of quantifiers the computing system may process, via the first machine learning model, text associated with a user to generate a sentiment associated with the text. The text may include a review of the user. The first machine learning model may include a sentiment analysis model. In this example, based on the sentiment, the computing system may generate a first quantifier of the plurality of quantifiers. The quantifiers may include any quantifier described above in connection with FIG. 1. Each quantifier of the plurality of quantifiers may correspond to a user that is a member of the entity described above in step 402. By generating quantifiers, for example, for each user, the computing system may be able to determine which users may be good examples for other users that may need training.

At step 406, the computing system may determine a set of users based on the quantifiers generated in step 404. The quantifiers may be used to determine a set of users that may be high performers within the organization. The set of users may then be used to generate an additional data structure which may be used by the computing system (e.g., via a machine learning model) to generate recommendations, for example, related to preventing employee turnover at an organization. In one example, the computing system may determine, based on the plurality of quantifiers, a set of users, wherein each user of the set of users is associated with a quantifier that is higher than a threshold quantifier.

At step 408, the computing system may generate a second data structure based on the set of users. For example, the computing system may generate a positive relationship data structure (e.g., a graph that is generated based on high performers) that includes a second set of nodes and a second set of edges. A first portion of the second set of nodes may correspond to the set of users determined in step 406. Each edge of the second set of edges may correspond to an interaction between a user represented in the first portion and a user represented in a second portion of the second set of nodes. For example, the first portion of the second set of nodes may include users that were determined to be high performers within an organization. The edges in the second set of edges may correspond to interactions that the high performers had with other users, employees, clients, vendors, etc. By constructing the second data structure in this way, the computing system may be able to generate a data structure that can act as a counterfactual sample to the data structure that was generated in step 402. The two data structures may be compared, for example, to identify causes of employee turnover at an organization. In one example, generating the second data structure may include determining a set of users, wherein each user in the set of users satisfies a threshold performance metric; determining a set of interactions, wherein each interaction in the set of interactions is associated with a user in the set of users; and based on the set of interactions, generating one or more nodes or one or more edges of the positive relationship data structure.

At step 410, the computing system may generate node embeddings based on the first and second data structures (e.g., the first data structure generated in step 402 and the second data structure generated in step 408). For example, the computing system may generate, via a second machine learning model, a first node embedding for a first node in the negative relationship data structure and may generate a second node embedding for a second node in the positive relationship data structure. The computing system may generate node embeddings for each node in the first graph that corresponds to a user that is still a member of the entity. For example, the computing system may avoid generating node embeddings for users that have left the organization. By doing so, the computing system can generate node embeddings that can be used to determine changes or recommendations for users that are still members of the entity. A node embedding generated by the computing system may include any node embedding described above in connection with FIG. 1. The node embeddings may be compared to determine whether two nodes are similar. The computing system may generate a recommendation that a user associated with a first node should train a user associated with a second node, for example, if two nodes are similar (e.g., as described in more detail below).

At step 412, the computing system may generate a recommendation based on a distance score associated with node embeddings generated in step 410. For example, based on a distance score associated with the first node embedding and the second node embedding, the computing system may generate an edge that connects the first node of the negative relationship data structure with the second node of the positive relationship data structure. The distance score may be Cosine distance, Euclidean distance, or any other distance score described above in connection with FIG. 1. The edge that connects the first node with the second node may indicate that a user represented by the first node should be trained by a user represented by the second node. By generating a connection between the two nodes, the computing system may keep track of training recommendations.

In some embodiments, a recommendation to have a user train another user may be based on whether the distance score satisfies a threshold. For example, a recommendation to have one user train another user may be based on whether the distance score that is generated using corresponding node embeddings is lower than a threshold distance score. In one example, generating a recommendation (e.g., and generating an edge that connects the first node of the negative relationship data structure with the second node of the positive relationship data structure) may be based on the distance score satisfying a threshold distance score.

In some embodiments, the computing system may compare the first data structure (e.g., the negative relationship data structure) with the second data structure (e.g., the positive relationship data structure) to determine a recommendation. For example, based on comparing the positive relationship data structure with the negative relationship data structure, the computing system may determine a first node for modification. The computing system may generate a recommendation associated with the first node.

Comparing the first data structure with the second data structure may enable the computing system to determine differences between high-performing users and other users that may be causing users (e.g., employees) to leave an organization.

In some embodiments, the computing system may compare the first data structure with the second data structure by comparing a first embedding that represents the first data structure (e.g., that represents the entire first data structure as a whole) with a second embedding that represents the second data structure. For example, the computing system may generate a first data structure embedding representative of the negative relationship data structure and may generate a second data structure embedding representative of the positive relationship data structure. The computing system may determine that a distance score associated with the first data structure embedding and the second data structure embedding satisfies a threshold. If the threshold is satisfied, the computing system may determine that the two data structures are similar. By doing so, the computing system may be able to recommend a feature that is present in the positive relationship data structure but missing in the negative relationship data structure as a feature to change (e.g., for one or more users in the negative relationship data structure). For example, based on the distance score satisfying a threshold, the computing system may determine a feature, wherein a first value of the feature for the positive relationship data structure is greater than (e.g., or less than, for example, depending on the feature) a second value of the feature for the negative relationship data structure. Based on the feature, the computing system may send a recommendation to a user device. For example, the computing system may send a recommendation to increase a salary of one or more users if the identified feature is income level. As an additional example, the computing system may send a recommendation to hire additional employees for a particular team if the identified feature is team size (e.g., the size of the team in the negative relationship data structure is smaller (e.g., by more than a threshold number of employees) than the size of the team in the positive relationship data structure).

In some embodiments, the computing system may determine a feature by comparing a list of features. For example, the list of features may include salary, the number of team members, and the number of users (e.g., the average number of nodes that are connected to users via an edge).

In some embodiments, the computing system may generate a visualization of one or more data structures described above. For example, the computing system may generate a user interface comprising a visualization of the negative relationship data structure and the positive relationship data structure and may cause display of the user interface.

It is contemplated that the steps or descriptions of FIG. 4 may be used with any other embodiment of this disclosure. In addition, the steps and descriptions described in relation to FIG. 4 may be done in alternative orders or in parallel to further the purposes of this disclosure. For example, each of these steps may be performed in any order, in parallel, or simultaneously to reduce lag or increase the speed of the system or method. Furthermore, it should be noted that any of the components, devices, or equipment discussed in relation to the figures above could be used to perform one or more of the steps in FIG. 4.

The above-described embodiments of the present disclosure are presented for purposes of illustration and not of limitation, and the present disclosure is limited only by the claims which follow. Furthermore, it should be noted that the features and limitations described in any one embodiment may be applied to any embodiment herein, and flowcharts or examples relating to one embodiment may be combined with any other embodiment in a suitable manner, done in different orders, or done in parallel. In addition, the systems and methods described herein may be performed in real-time. It should also be noted that the systems and/or methods described above may be applied to, or used in accordance with, other systems and/or methods.

The present techniques will be better understood with reference to the following enumerated embodiments:
1. A method comprising: generating a negative relationship data structure comprising a first set of nodes and a first set of edges, wherein a first subset of the first set of nodes corresponds to users who were previously members of an entity but are no longer members, and wherein each edge of the first set of edges corresponds to an interaction between a user represented in the first subset and a user represented in a second subset of the first set of nodes; generating, via a machine learning model, a plurality of quantifiers indicative of user performance within the entity, wherein each quantifier of the plurality of quantifiers corresponds to a user that is a member of the entity; determining, based on the plurality of quantifiers, a set of users, wherein each user of the set of users is associated with a quantifier that is higher than a threshold quantifier; generating a positive relationship data structure comprising a second set of nodes and a second set of edges; based on comparing the positive relationship data structure with the negative relationship data structure, determining a first node for modification; and generating a recommendation associated with the first node.
2. The method of any of the preceding embodiments, wherein determining a first node for modification comprises: generating a first node embedding based on a first node in the positive relationship data structure; generating a second node embedding based on a second node in the negative relationship data structure; and based on a distance score associated with the first node embedding and the second node embedding, generating an edge that connects the first node of the negative relationship data structure with the second node of the positive relationship data structure.
3. The method of any of the preceding embodiments, wherein generating an edge that connects the first node of the negative relationship data structure with the second node of the positive relationship data structure is based on the distance score satisfying a threshold distance score.
4. The method of any of the preceding embodiments, further comprising: generating a first data structure embedding representative of the negative relationship data structure and a second data structure embedding representative of the positive relationship data structure; determining that a distance score associated with the first data structure embedding and the second data structure embedding satisfies a threshold; based on the distance score satisfying a threshold, determining a feature, wherein a first value of the feature for the positive relationship data structure is greater than a second value of the feature for the negative relationship data structure; and based on the feature, sending a recommendation to a user device.
5. The method of any of the preceding embodiments, wherein generating the plurality of quantifiers comprises: processing, via the machine learning model, text associated with a user to generate a sentiment associated with the text, wherein the text comprises a review of the user, and wherein the machine learning model comprises a sentiment analysis model; and based on the sentiment, generating a first quantifier of the plurality of quantifiers.
6. The method of any of the preceding embodiments, further comprising: generating a user interface comprising a visualization of the negative relationship data structure and the positive relationship data structure; and causing display of the user interface.
7. The method of any of the preceding embodiments, wherein a first portion of the second set of nodes corresponds to the set of users, and wherein each edge of the second set of edges corresponds to an interaction between a user represented in the first portion and a user represented in a second portion of the second set of nodes.
8. The method of any of the preceding embodiments, further comprising: sending, to a user device and based on the recommendation associated with the first node, an indication of a modification associated with the negative relationship data structure.
9. A tangible, non-transitory, machine-readable medium storing instructions that, when executed by a data processing apparatus, cause the data processing apparatus to perform operations comprising those of any of embodiments 1-8.
10. A system comprising one or more processors; and memory storing instructions that, when executed by the processors, cause the processors to effectuate operations comprising those of any of embodiments 1-8.
11. A system comprising means for performing any of embodiments 1-8.

What is claimed is:

1. A database and file system for processing data to enable machine learning models to generate output by generating complementary graphical data structures, the system comprising:
one or more processors; and
a non-transitory, computer-readable medium having instructions recorded thereon that, when executed by the one or more processors, cause operations comprising:
generating a negative relationship data structure comprising a first set of nodes and a first set of edges, wherein a first subset of the first set of nodes corresponds to users who were previously members of an entity but are no longer members, and wherein each edge of the first set of edges corresponds to an interaction between a user represented in the first subset and a user represented in a second subset of the first set of nodes;
generating, via a first machine learning model, a plurality of quantifiers indicative of user performance within the entity, wherein each quantifier of the plurality of quantifiers corresponds to a user that is a member of the entity;
determining, based on the plurality of quantifiers, a set of users, wherein each user of the set of users is associated with a quantifier that is higher than a threshold quantifier;
generating a positive relationship data structure comprising a second set of nodes and a second set of edges, wherein a first portion of the second set of nodes corresponds to the set of users, and wherein each edge of the second set of edges corresponds to an interaction between a user represented in the first portion and a user represented in a second portion of the second set of nodes;
generating, via a second machine learning model, a first node embedding for a first node in the negative relationship data structure and a second node embedding for a second node in the positive relationship data structure; and
based on a distance score associated with the first node embedding and the second node embedding, generating an edge that connects the first node of the negative relationship data structure with the second node of the positive relationship data structure.

2. The system of claim 1, wherein generating an edge that connects the first node of the negative relationship data structure with the second node of the positive relationship data structure is based on the distance score satisfying a threshold distance score.

3. The system of claim 1, wherein generating the plurality of quantifiers comprises:
processing, via the first machine learning model, text associated with a user to generate a sentiment associated with the text, wherein the text comprises a review of the user, and wherein the first machine learning model comprises a sentiment analysis model; and
based on the sentiment, generating a first quantifier of the plurality of quantifiers.

4. The system of claim 1, wherein generating the positive relationship data structure comprises:
determining a set of users, wherein each user in the set of users satisfies a threshold performance metric;
determining a set of interactions, wherein each interaction in the set of interactions is associated with a user in the set of users; and
based on the set of interactions, generating one or more nodes or one or more edges of the positive relationship data structure.

5. A method comprising:
generating a negative relationship data structure comprising a first set of nodes and a first set of edges, wherein a first subset of the first set of nodes corresponds to users who were previously members of an entity but are no longer members, and wherein each edge of the first set of edges corresponds to an interaction between a user represented in the first subset and a user represented in a second subset of the first set of nodes;
generating, via a machine learning model, a plurality of quantifiers indicative of user performance within the entity, wherein each quantifier of the plurality of quantifiers corresponds to a user that is a member of the entity;
determining, based on the plurality of quantifiers, a set of users, wherein each user of the set of users is associated with a quantifier that is higher than a threshold quantifier;
generating a positive relationship data structure comprising a second set of nodes and a second set of edges;
based on comparing the positive relationship data structure with the negative relationship data structure, determining a first node for modification; and
generating a recommendation associated with the first node.

6. The method of claim 5, wherein determining a first node for modification comprises:
generating a first node embedding based on a first node in the positive relationship data structure;
generating a second node embedding based on a second node in the negative relationship data structure; and
based on a distance score associated with the first node embedding and the second node embedding, generating an edge that connects the first node of the negative relationship data structure with the second node of the positive relationship data structure.

7. The method of claim 6, wherein generating an edge that connects the first node of the negative relationship data structure with the second node of the positive relationship data structure is based on the distance score satisfying a threshold distance score.

8. The method of claim 5, further comprising:
generating a first data structure embedding representative of the negative relationship data structure and a second data structure embedding representative of the positive relationship data structure;
determining that a distance score associated with the first data structure embedding and the second data structure embedding satisfies a threshold;
based on the distance score satisfying a threshold, determining a feature, wherein a first value of the feature for the positive relationship data structure is greater than a second value of the feature for the negative relationship data structure; and
based on the feature, sending a recommendation to a user device.

9. The method of claim 5, wherein generating the plurality of quantifiers comprises:
processing, via the machine learning model, text associated with a user to generate a sentiment associated with the text, wherein the text comprises a review of the user, and wherein the machine learning model comprises a sentiment analysis model; and
based on the sentiment, generating a first quantifier of the plurality of quantifiers.

10. The method of claim 5, further comprising:
generating a user interface comprising a visualization of the negative relationship data structure and the positive relationship data structure; and
causing display of the user interface.

11. The method of claim 5, wherein a first portion of the second set of nodes corresponds to the set of users, and wherein each edge of the second set of edges corresponds to an interaction between a user represented in the first portion and a user represented in a second portion of the second set of nodes.

12. The method of claim 5, further comprising:
sending, to a user device and based on the recommendation associated with the first node, an indication of a modification associated with the negative relationship data structure.

13. A non-transitory, computer-readable medium comprising instructions that when executed by one or more processors, cause operations comprising:
generating a negative relationship data structure comprising a first set of nodes and a first set of edges, wherein a first subset of the first set of nodes corresponds to users who were previously members of an entity but are no longer members, and wherein each edge of the first set of edges corresponds to an interaction between a user represented in the first subset and a user represented in a second subset of the first set of nodes;
generating, via a machine learning model, a plurality of quantifiers indicative of user performance within the entity, wherein each quantifier of the plurality of quantifiers corresponds to a user that is a member of the entity;
based on comparing a positive relationship data structure with the negative relationship data structure, determining a first node for modification; and
generating a recommendation associated with the first node.

14. The medium of claim 13, further comprising:
determining, based on the plurality of quantifiers, a set of users, wherein each user of the set of users is associated with a quantifier that is higher than a threshold quantifier.

15. The medium of claim 13, wherein a first portion of a second set of nodes associated with the positive relationship data structure corresponds to a set of users determined based on the plurality of quantifiers, and wherein each edge of a second set of edges associated with the positive relationship data structure corresponds to an interaction between a user represented in the first portion and a user represented in a second portion of the second set of nodes.

16. The medium of claim 13, wherein determining a first node for modification comprises:
generating a first node embedding based on a first node in the positive relationship data structure;
generating a second node embedding based on a second node in the negative relationship data structure; and
based on a distance score associated with the first node embedding and the second node embedding, generating an edge that connects the first node of the negative relationship data structure with the second node of the positive relationship data structure.

17. The medium of claim 16, wherein generating an edge that connects the first node of the negative relationship data structure with the second node of the positive relationship data structure is based on the distance score satisfying a threshold distance score.

18. The medium of claim 13, further comprising:
generating a first data structure embedding representative of the negative relationship data structure and a second data structure embedding representative of the positive relationship data structure;
determining that a distance score associated with the first data structure embedding and the second data structure embedding satisfies a threshold;
based on the distance score satisfying a threshold, determining a feature, wherein a first value of the feature for the positive relationship data structure is greater than a second value of the feature for the negative relationship data structure; and
based on the feature, sending a recommendation to a user device.

19. The medium of claim 13, wherein generating the plurality of quantifiers comprises:
processing, via the machine learning model, text associated with a user to generate a sentiment associated with the text, wherein the text comprises a review of the user, and wherein the machine learning model comprises a sentiment analysis model; and
based on the sentiment, generating a first quantifier of the plurality of quantifiers.

20. The medium of claim 13, wherein a first portion of a second set of nodes associated with the positive relationship data structure corresponds to a set of users, the users having been determined based on the plurality of quantifiers, and wherein each edge of a second set of edges associated with the positive relationship data structure corresponds to an interaction between a user represented in the first portion and a user represented in a second portion of the second set of nodes.
